(19) United States
(12) Patent Application Publication
(10) Pub. No.: US 2024/0124704 A1
(43) Pub. Date: Apr. 18, 2024

(54) Low Emission Polyoxymethylene Composition With Color Stability

(71) Applicant: Celanese International Corporation, Irving, TX (US)

(72) Inventors: Klaus Kurz, Kelsterbach (DE); Kirsten Markgraf, Weinheim (DE)

(21) Appl. No.: 18/479,237

(22) Filed: Oct. 2, 2023

Related U.S. Application Data
(60) Provisional application No. 63/412,592, filed on Oct. 3, 2022.

(51) Int. Cl. C08L 59/02; C08K 5/098; C08K 5/3445

(52) U.S. Cl. CPC C08L 59/02; C08K 5/098; C08K 5/3445; C08L 2207/04

(57) ABSTRACT

A polyoxymethylene polymer composition is disclosed containing a formaldehyde stabilizer package. The formaldehyde stabilizer package contains, in one embodiment, a substituted hydantoin that has been found to dramatically reduce formaldehyde emissions either alone or in combination with another emission control agent.

### RELATED APPLICATIONS

The present application is based upon and claims priority to U.S. Provisional Patent Application Ser. No. 63/412,592, having a filing date of Oct. 3, 2022, which are all incorporated herein by reference.

### BACKGROUND

Polyacetal polymers, which are commonly referred to as polyoxymethylenes, have become established as exceptionally useful engineering materials in a variety of applications. Polyoxymethylene polymers, for instance, are widely used in constructing molded parts, such as parts for use in the automotive industry and the electrical industry. Polyoxymethylene polymers, for instance, have excellent mechanical properties, fatigue resistance, abrasion resistance, chemical resistance, and moldability.

Although polyacetal resins possess many useful properties, the polymers have a tendency to degrade when heated and are inherently unstable in an oxidative atmosphere or in an acidic or alkaline environment. In particular, polyacetal resins have a tendency to emit formaldehyde during processing and after the polymer has been molded into a part. Formaldehyde is not only a contaminant, but can also adversely affect metallic components that may be placed in association with the polymer. For example, formaldehyde readily oxidizes to formic acid which can corrode metals or cause discoloration.

In view of the above, those skilled in the art have attempted to combine polyacetal polymers with various compounds in order to lower formaldehyde emissions. For instance, in the past, polyacetal polymers have been combined with melamines in order to achieve lower formaldehyde emission performance. In addition, various other chemical compounds have been suggested for lowering formaldehyde emissions.

Although various chemical compounds used in the past have successfully lowered formaldehyde emissions from products made from polyoxymethylene polymers, further improvements in formaldehyde emissions are needed. For instance, stricter government regulations continue to require further improvements in reducing formaldehyde emissions.

Unfortunately, however, when additives are combined with a polyacetal polymer in order to enhance one property, the additive may have an adverse impact on another property. For example, adding greater amounts of formaldehyde scavengers into polyoxymethylene polymer compositions can compromise one or more properties of the polymer. For instance, excess amounts of formaldehyde scavengers may cause the molded articles to discolor during use and/or begin to adversely affect other physical properties.

In view of the above, a need exists for an improved formaldehyde stabilizer package capable of further reducing formaldehyde emissions without adversely affecting other properties of the polyoxymethylene polymer composition.

### SUMMARY

In general, the present disclosure is directed to a polymer composition containing primarily a polyacetal resin and to molded products made from the composition. The polymer composition of the present disclosure is particularly formulated to exhibit ultra-low formaldehyde emissions. For example, polyoxymethylene polymer compositions formulated in accordance with the present disclosure can exhibit a formaldehyde emission when tested according to VDA Test 275 of less than about 2 ppm, such as less than about 1 ppm. The VDA 275 Test (German Automotive Industry Recommendation No. 275) is documented by Kraftfahrwesen e. V., July 1994.

In one embodiment, for instance, the polymer composition of the present disclosure comprises a polyoxymethylene polymer in combination with a formaldehyde stabilizer package for reducing formaldehyde emissions. The formaldehyde stabilizer package, in one embodiment, can comprise at least one emission control agent. In particular, it was discovered that a particular substituted hydantoin is very effective at reducing formaldehyde emissions. The substituted hydantoin can be used alone or in combination with other hydrazides and/or other emission control agents. In one embodiment, the polymer composition is formulated to contain the substituted hydantoin without any significant adverse impacts upon other properties of molded articles made from the composition. For instance, in one embodiment, molded articles made according to the present disclosure exhibit very stable color qualities, making the polymer composition well suited for producing interior automotive trim pieces and the like.

In one embodiment, for instance, the present disclosure is directed to a polyoxymethylene polymer in combination with a formaldehyde stabilizer package that comprises a substituted hydantoin alone or in combination with one or more aliphatic carboxylic hydrazides. When the substituted hydantoin is present in combination with an aliphatic carboxylic hydrazide, the weight ratio between the aliphatic carboxylic hydrazide and the substituted hydantoin can be from about 1:1.1 to about 1:8.5, such as from about 1:1.5 to about 1:7.5, such as from about 1:2 to about 1:5.5.

The substituted hydantoin can be present in the polymer composition in an amount less than about 0.6% by weight, such as in an amount less than about 0.5% by weight, such as in an amount less than about 0.4% by weight, such as in an amount less than about 0.35% by weight, such as in an amount less than about 0.3% by weight, and generally in an amount greater than about 0.01% by weight, such as in an amount greater than about 0.05% by weight, such as in an amount greater than about 0.07% by weight, such as in an amount greater than about 0.09% by weight, such as in an amount greater than about 0.1% by weight, such as in an amount greater than about 0.12% by weight, such as in an amount greater than about 0.15% by weight, such as in an amount greater than about 0.17% by weight, such as in an amount greater than about 0.2% by weight. The substituted hydantoin can contain two hydrazino carbonyl alkyl groups. The substituted hydantoin can have a melting point of less than about 150° C., such as less than about 140° C., such as less than about 130° C., such as less than about 125° C., and generally greater than about 100° C. The substituted hydantoin can have a relatively low cure temperature of less than about 125° C., such as less than about 120° C., such as less than about 115° C., and generally greater than about 100° C., such as greater than about 105° C. In one particular embodiment, the substituted hydantoin comprises 4-isopropyl-2,5-dioxoimidazolidine-1,3-di(propionohydrazide).

As described above, the substituted hydantoin can be combined with an aliphatic carboxylic hydrazide. The aliphatic carboxylic hydrazide can be a dihydrazide. Examples of dihydrazides include sebacic acid dihydrazide, dodecanedioic acid dihydrazide, or mixtures thereof. When present, the aliphatic carboxylic dihydrazide can be present in the polymer composition in relatively minor amounts due to the presence of the substituted hydantoin. For instance, the aliphatic carboxylic hydrazide can be present in the polymer composition in an amount less than the substituted hydantoin described above and in an amount less than about 0.15% by weight, such as in an amount less than about 0.1% by weight.

The formaldehyde stabilizer package can also comprise an acid scavenger. The acid scavenger can comprise a metal salt of an organic acid. In one particular embodiment, the acid scavenger is an organic acid that has a carbon chain length of 8 carbon atoms or less. For example, in one aspect, the acid scavenger comprises tricalcium citrate. The acid scavenger can be present in the polymer composition in an amount less than about 0.5% by weight, such as in an amount less than about 0.2% by weight, such as in an amount less than about 0.08% by weight, and in an amount greater than about 0.001% by weight.

Other optional components that can be contained in the polymer composition include a nucleant in an amount from about 0.05% to about 1% by weight, a phenolic antioxidant in an amount from about 0.05% to about 2% by weight, and a lubricant in an amount from about 0.05% to about 1.5% by weight. The polymer composition can also optionally contain a thermoplastic elastomer, reinforcing fibers, and/or a UV stabilizer.

The polymer composition and molded articles made from the composition can display excellent physical and mechanical properties. The polymer composition, for instance, can display a yellowness index when tested according to Test DIN 6167 at a molding temperature of 205° C. of less than 0, such as less than about −1, such as less than about −2, such as less than about −3, and greater than about −10. The polymer composition can also display an L* value at a molding temperature of 205° C. of less than about 80, such as less than about 78, such as less than about 76, and greater than about 60, such as greater than about 70.

The polymer composition can also be tested for formaldehyde emission according to a 10-Liter Bag Test. Polymer compositions made according to the present disclosure, for instance, when tested according to the 10-Liter Bag Test can display a formaldehyde emission of less than about 100 μg/m³, such as less than about 80 μg/m³, such as less than about 60 μg/m³, such as less than about 55 μg/m³.

All different types of molded articles can be made according to the present disclosure from the polymer composition containing the formaldehyde stabilizer package. For instance, the molded article can comprise an interior automotive part. The molded article can comprise a latch, a lever, a gear, a pivot housing, a speaker grill, a door handle, a decorative trim piece, a bracket, a seat rail, or the like. Medical products can also be made from the polymer composition, such as components of an inhaler or an injector.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of the interior of an automobile illustrating various molded articles that may be made in accordance with the present disclosure;

FIG. 2 is a perspective view of a medical inhaler that may be made from molded parts in accordance with the present disclosure; and

FIG. 3 is a perspective view of a medical injector containing molded parts made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition containing a polyacetal resin, particularly a polyoxymethylene copolymer, that exhibits low formaldehyde emissions. The polymer composition is well suited for use in molding processes for producing molded articles. The polymer composition can contain one or more coloring agents for producing molded articles having any desired color. The molded articles can be used in a limitless variety of different applications and in multiple fields. In one embodiment, for instance, molded articles may be made according to the present disclosure that are designed to function as automotive parts, such as automotive parts designed to be used in the interior of vehicles, such as cars and trucks.

More particularly, the present disclosure is directed to a polymer composition containing a polyacetal resin in combination with a formaldehyde stabilizer package. The formaldehyde stabilizer package comprises at least one emission control agent. In particular, it was found that a substituted hydantoin having particular properties was found to be a very effective emission control agent alone or in combination with other hydrazides. The substituted hydantoin of the present disclosure, for instance, was found to dramatically lower formaldehyde emissions from the polyoxymethylene polymer composition without adversely interfering with other properties of the polymer composition or of molded articles made from the composition. For instance, the substituted hydantoin has been found to greatly decrease formaldehyde emissions while also producing polymer compositions having excellent color retention and stability properties.

In one aspect, the substituted hydantoin contains two hydrazino carbonyl alkyl groups. The particular substituted hydantoin for incorporation into the polymer composition, in one aspect, can have a relatively low melting point and a relatively low curing temperature. For instance, the melting point of the substituted hydantoin can be less than about 150° C., such as less than about 140° C., such as less than about 130° C., such as less than about 125° C., such as less than about 122° C. The melting point can be greater than about 100° C., such as greater than about 110° C., such as greater than about 115° C., such as greater than about 118° C. The substituted hydantoin can be configured to cure at a temperature of less than about 125° C., such as less than about 120° C., such as less than about 115° C., such as less than about 112° C., and generally greater than about 100° C., such as greater than about 105° C. (after a one hour exposure to the above temperatures).

In one particular embodiment, the substituted hydantoin can comprise 4-isopropyl-2,5-dioxoimidazolidine-1,3-di(propionohydrazide).

In the past, a hydantoin compound having two hydrazino carbonyl alkyl groups has been suggested for use in polyacetal resin compositions for lowering the generation of formaldehyde from a molded article. For instance, U.S. Patent Publication No. 2021/0355314 is directed to a polyacetal resin composition and is incorporated herein by reference. In the '314 application, however, the examples generally teach extremely low amounts of the hydantoin compound and teach that the hydantoin compound alone produces unfavorable results. In contrast, it was discovered that selected amounts of the substituted hydantoin alone can be very effective at reducing formaldehyde emissions without any adverse consequences. In addition, it was discovered that using the substituted hydantoin compound in combination with other hydrazide compounds can be very effective at lowering formaldehyde emissions within particular weight ratios while preserving the mechanical and aesthetic properties of the polymer composition and of molded articles made from the composition.

In one embodiment, for instance, the formaldehyde stabilizer package of the present disclosure can contain the substituted hydantoin emission control agent in combination with one or more aliphatic carboxylic hydrazides. The aliphatic carboxylic hydrazide can be a dihydrazide. Particular examples of dihydrazides include, for instance, sebacic acid dihydrazide, dodecanedioic acid dihydrazide, or mixtures thereof.

In one embodiment, the formaldehyde stabilizer package of the present disclosure contains the same or greater amounts of the substituted hydantoin in relation to the amount of aliphatic carboxylic hydrazides present in the formulation. In one aspect, for instance, one or more aliphatic carboxylic hydrazides are present in relation to the substituted hydantoin at a weight ratio of from about 1:1.1 to about 1:8.5, such as from about 1:1.5 to about 1:7.5, such as from about 1:2 to about 1:5.5. Although the weight ratios can vary depending upon the particular application, the above weight ratios have been found to be particularly effective at reducing formaldehyde emissions while producing molded articles with enhanced color stability, making the molded articles particularly well suited for producing trim pieces for the interior of vehicles, such as automobiles, or for producing consumer appliance parts.

One or more aliphatic carboxylic hydrazides can be present in the polymer composition generally in an amount from about 0.001% by weight to about 1% by weight, including all increments of 0.1% by weight therebetween. When combined with a substituted hydantoin, however, the amount of aliphatic carboxylic hydrazides present in the polymer composition can be minimized. For instance, in one embodiment, one or more aliphatic carboxylic hydrazides are present in the polymer composition in an amount less than 0.2% by weight, such as in an amount less than about 0.15% by weight, such as in an amount less than about 0.12% by weight, such as in an amount less than about 0.1% by weight, such as in an amount less than about 0.09% by weight, such as in an amount less than about 0.08% by weight. Minimizing the amount of aliphatic carboxylic hydrazides present in the composition can offer various advantages and benefits including minimizing free hydrazide in the composition and providing color stability.

The amount of the substituted hydantoin present in the polymer composition can vary depending upon whether the substituted hydantoin is present alone in the composition or in combination with other emission control agents. In general, the substituted hydantoin can be present in the polymer composition in an amount from about 0.0001% by weight to about 1% by weight, including all increments of 0.01% by weight therebetween. In one embodiment, the substituted hydantoin is present in the polymer composition in amounts greater than any other emission control agents present in the composition. For instance, the substituted hydantoin can be present in the polymer composition in an amount greater than 0.07% by weight, such as in an amount greater than about 0.09% by weight, such as in an amount greater than about 0.1% by weight, such as in an amount greater than about 0.12% by weight, such as in an amount greater than about 0.15% by weight, such as in an amount greater than about 0.17% by weight, such as in an amount greater than about 0.2% by weight, such as in an amount greater than about 0.22% by weight, such as in an amount greater than about 0.24% by weight. The substituted hydantoin can be present in the polymer composition, in various embodiments, in an amount less than about 0.8% by weight, such as in an amount less than about 0.6% by weight, such as in an amount less than about 0.55% by weight, such as in an amount less than about 0.5% by weight, such as in an amount less than about 0.45% by weight, such as in an amount less than about 0.4% by weight, such as in an amount less than about 0.35% by weight, such as in an amount less than about 0.3% by weight.

In one embodiment, the formaldehyde stabilizer package includes the emission control agents described above while excluding other formaldehyde scavengers used in the past. For instance, the polymer composition can be formulated to be melamine-free. In fact, the polymer composition can be formulated so as to not contain any melamines or any melamine derivatives. In one aspect, the polymer composition does not contain any guanamine compounds.

Other emission control agents that can be present in the formaldehyde stabilizer package include an amino acid, such as arginine, or an alkylene urea, such as ethylene urea. Additional emission control agents can be present in the polymer composition generally in an amount from about 0.01% by weight to about 0.5% by weight, including all increments of 0.01% by weight therebetween.

The formaldehyde stabilizer package of the present disclosure can also contain an acid scavenger. It is believed that certain acid scavengers are particularly well suited for combining with the substituted hydantoin.

In one particular embodiment, for instance, the acid scavenger can comprise a metal salt of an organic acid, wherein the organic acid has a carbon chain length of 8 carbon atoms or less. For example, in one particular embodiment, the acid scavenger can comprise a metal citrate, such as tricalcium citrate.

In other embodiments, the acid scavenger can comprise a salt of a carboxylic acid, such as a metal salt of a fatty acid. The carboxylic acid salt may comprise an alkaline earth metal salt, for instance, of a fatty acid. The cation of the salt, for instance, may comprise calcium, barium, lithium, sodium, magnesium, zinc, or the like.

The fatty acid can contain a carbon chain length of generally from about 3 carbon atoms to about 20 carbon atoms. The fatty acid may comprise a dicarboxylic acid or a tricarboxylic acid. Particular examples include metal salts of propionic acid, stearic acid, butanoic acid, hexanoic acid, decanoic acid, lauric acid, myristic acid, palmitic acid, and the like. Particular examples include calcium propionate, calcium 12-hydroxystearate, calcium stearate, and mixtures thereof.

One or more acid scavengers can be present in the polymer composition generally in an amount from about 0.05% by weight to about 2% by weight, including all increments of 0.1% by weight therebetween. In some embodiments, especially when using tricalcium citrate, relatively small amounts of an acid scavenger are needed. For instance, the acid scavenger can be present in an amount less than 1% by weight, such as less than about 0.8% by weight, such as less than about 0.5% by weight, such as less than about 0.2% by weight, such as even in an amount less than about 0.08% by weight. One or more acid scavengers are generally present in an amount greater than 0.001% by weight, such as in an amount greater than about 0.01% by weight.

When combined with a polyoxymethylene polymer, the formaldehyde stabilizer package of the present disclosure as described above can produce polymer compositions and molded articles with not only low formaldehyde emission properties, but also excellent mechanical properties and visual appeal.

For instance, in one embodiment, the polymer composition containing the polyoxymethylene polymer exhibits a formaldehyde emission pursuant to VDA 275 of less than about 2 ppm (μg/g), such as less than about 1 ppm, such as less than about 0.8 ppm, such as less than about 0.6 ppm, such as even less than about 0.4 ppm. The above formaldehyde emission characteristics can be obtained even when the test plaques have a thickness of 1 mm and are formed at a molding temperature of 205° C. In one aspect, the test can be run after the test plaque has been dried for two hours at 140° C.

Another formaldehyde emission test is the 10-Liter Bag Test. Polymer compositions made according to the present disclosure can display a formaldehyde emission when tested according to the 10-Liter Bag Test of less than about 100 μg/m³, such as less than about 80 μg/m³, such as less than about 60 μg/m³, such as less than about 55 μg/m³. The 10-Liter Bag Test can be conducted on specimens also molded at a temperature of 205° C.

Polymer compositions and molded articles made from the composition can also display excellent color stability. For instance, when tested according to DIN 6167 at a molding temperature of 205° C., the polymer composition can display a yellowness index of less than 0, such as less than about −1, such as less than about −2, such as less than about −3, and generally greater than about −10.

The polymer composition can also be tested according to the CIELAB color scale. As used herein, CIELab color values L*, a*, and b* are measured according to the color space specified by the International Commission on Illumination. The L*a*b* colourimetric system was standardized in 1976 by Commission Internationale de l'Eclairage (CIE). The CIELab L* value, utilized herein to define the darkness/lightness of the polymer composition, is a unit of colour measurement in the afore-mentioned CIELab system. A colour may be matched according to CIELab. In the L*a*b* colourimetric system, L* refers to lightness expressed by a numerical value.

For example, when molded at a temperature of 205° C., the polymer composition can display an L* value of less than about 80, such as less than about 78, such as less than about 76, and generally greater than about 60, such as greater than about 70, such as greater than about 72.

The formaldehyde stabilizer package of the present disclosure is particularly formulated to be combined with a polyoxymethylene polymer.

In general, any suitable polyoxymethylene polymer may be incorporated into the polymer composition.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.01 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

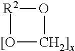

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.01 to 5 mol. %, such as from 0.5 to 4 mol. %, of one of the above-mentioned comonomers. In one embodiment, the polyoxymethylene polymer contains relatively low amounts of comonomer. For instance, the comonomer can be present in an amount less than about 2 mol. %, such as less than about 1.5 mol. %, such as less than about 1 mol. %, such as less than about 0.8 mol. %, such as less than about 0.6 mol. %.

The polymerization can be effected as precipitation polymerization or in the melt. For example, the polyoxymethylene copolymer can be formed through solution hydrolysis in which a precipitate or powder is formed that has extremely low amounts of unstable end groups. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal positions. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to or instead of the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer can be produced using a cationic polymerization process followed by solution hydrolysis to remove any unstable end groups. During cationic polymerization, a glycol, such as ethylene glycol or methylal can be used as a chain terminating agent. A heteropoly acid, triflic acid or a boron compound may be used as the catalyst.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally have a melt flow index (MFI) ranging from about 0.1 to about 80 cm³/10 min, as determined according to ISO 1133 at 190° C. and 2.16 kg. In one embodiment, the polyoxymethylene polymer may have a melt flow index of from about 5 cm³/10 min to about 15 cm³/10 min, such as from about 8 cm³/10 min to about 12 cm³/10 min. In an alternative embodiment, a polyoxymethylene polymer may be used that has a relatively high melt flow index. For instance, the polyoxymethylene polymer may have a melt flow index of from about 18 cm³/10 min to about 40 cm³/10 min, such as from about 20 cm³/10 min to about 35 cm³/10 min.

Suitable commercially available polyoxymethylene polymers are available under the trade name Hostaform® (HF) by Celanese.

The polyoxymethylene polymer may be present in the polyoxymethylene polymer composition in an amount of at least 50 wt. %, such as at least 60 wt. %, such as at least 70 wt. %, such as at least 80 wt. %, such as at least 85 wt. %, such as at least 90 wt. %, such as at least 93 wt. %. In general, the polyoxymethylene polymer is present in an amount of less than about 100 wt. %, such as less than about 99 wt. %, such as less than about 97 wt. %, wherein the weight is based on the total weight of the polyoxymethylene polymer composition.

The polymer composition of the present disclosure may also contain other known additives such as, for example, antioxidants, UV stabilizers or heat stabilizers, impact modifiers and/or reinforcing fibers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. Other embodiments of light stabilizers include 2,2,6,6-tetramethyl-4-piperidyl compounds, e.g., bis(2,2,6,6-tetramethyl-4-piperidyl) sebacate or the polymer of dimethyl succinate and 1-(2-hydroxyethyl)-4-hydroxy-2,2,6,6-tetramethyl-4-piperidine. In one embodiment, the light stabilizer may comprise 2-(2H-benzzotriazol-2-yl) 4,6-bis(1-ethyl-1-phenyl-ethyl)phenol. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a coloring agent may be present. Coloring agents that may be used include any desired inorganic pigments, such as titanium dioxide, ultramarine blue, cobalt blue, and other organic pigments and dyes, such as phthalocyanines, anthraquinnones, and the like. Other coloring agents include carbon black or various other polymer-soluble dyes. In one embodiment, a combination of coloring agents may be included in the polymer composition. For instance, the polymer composition may contain titanium dioxide in combination with carbon black. In an alternative embodiment, the coloring agents present in the polymer composition may comprise titanium dioxide in combination with at least one color pigment, such as a yellow pigment and a green pigment and optionally further in combination with carbon black. The coloring agent may be present in the composition in an amount of at least about 0.01 wt. %, such as at least about 0.05 wt. %, such as at least about 0.1 wt. %, such as at least about 0.5 wt. %, such as at least about 0.8 wt. %, such as at least about 1 wt. % and less than about 5 wt. %, such as less than about 2.5 wt. %, such as less than about 1 wt. %, wherein the weight is based on the total weight of the respective polymer composition.

Fillers that may be included in the composition include glass beads, wollastonite, loam, molybdenum disulfide or graphite, and/or inorganic or organic fibers.

Reinforcing fibers which may be included in the composition are mineral fibers, such as glass fibers, polymer fibers, in particular organic high-modulus fibers, such as aramid fibers, metal fibers, such as steel fibers, carbon fibers, natural fibers, and/or fibers from renewable resources.

These fibers may be in modified or unmodified form, e.g. provided with a sizing, or chemically treated, in order to improve adhesion to the polymer. Glass fibers are particularly preferred.

Glass fibers are provided with a sizing to protect the glass fiber, to smooth the fiber but also to improve the adhesion between the fiber and the matrix material. A sizing usually comprises silanes, film forming agents, lubricants, wetting agents, adhesive agents optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes. Sizings based on polyurethanes may be used advantageously.

The reinforcing fibers may be compounded into the polyoxymethylene matrix, for example in an extruder or kneader. However, the reinforcing fibers may also advantageously take the form of continuous-filament fibers sheathed or impregnated with the polyoxymethylene molding composition in a process suitable for this purpose, and then processed or wound up in the form of a continuous strand, or cut to a desired pellet length so that the fiber lengths and pellet lengths are identical. An example of a process particularly suitable for this purpose is the pultrusion process.

The reinforcing fibers can be present in the molding composition in an amount ranging from 5 to 45 wt.-%, such as from 10 to 40 wt.-%, wherein the weight is based on the total weight of the composition.

The polymer composition may further comprise an impact modifier such as a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U).

In one particular embodiment, a thermoplastic polyurethane elastomer is used. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(ε-caprolactone)diol; and polyether diols such as poly(tetramethylene ether)glycol, poly(propylene oxide)glycol, poly(ethylene oxide)glycol, polycarbonate diol and/or a polyester polycarbonate diol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

The amount of thermoplastic elastomer contained in the polymer composition can vary depending upon various factors. For instance, the thermoplastic elastomer can be present in an amount ranging from about 0.5% by weight to about 50% by weight. In one embodiment, for instance, a thermoplastic elastomer or impact modifier may be present in the composition in an amount less than about 25% by weight, such as in an amount less than about 15% by weight, such as in an amount less than about 10% by weight. The thermoplastic elastomer or impact modifier is generally present in an amount greater than about 2% by weight, such as in an amount greater than about 5% by weight, such as in an amount greater than about 8% by weight, such as in an amount greater than about 10% by weight.

In one embodiment, when an impact modifier or thermoplastic elastomer is present in the composition, the composition can also include a coupling agent. The coupling agent may comprise a polyisocyanate, such as a diisocyanate or triisocyanate. The coupling agent can be present generally in an amount from about 0.1% to about 2% by weight, such as from about 0.1% to about 1% by weight.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like.

The polymer composition of the present disclosure can be used to produce various molded parts. The parts can be formed through any suitable molding process, such as an injection molding process or through a blow molding process. Polymer articles that may be made in accordance with the present disclosure include knobs, door handles, automotive decorative trim pieces, and the like without limitation. Other polymer articles, for instance, that may be made in accordance with the present disclosure include latches, levers, gears, pivot housings, speaker grills, and the like.

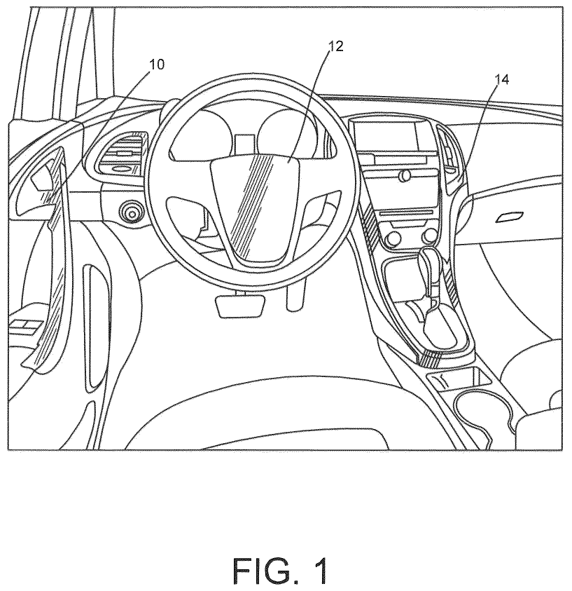

For instance, referring to FIG. 1, an automotive interior is shown illustrating various automotive parts that may be made in accordance with the present disclosure. The polymer composition, for instance, may be used to produce automotive part 10, which comprises at least a portion of an interior door handle. The polymer composition may also be used to produce a part on the steering column such as automotive part 12. In general, the polymer composition can be used to mold any suitable decorative trim piece or bezel, such as trim piece 14.

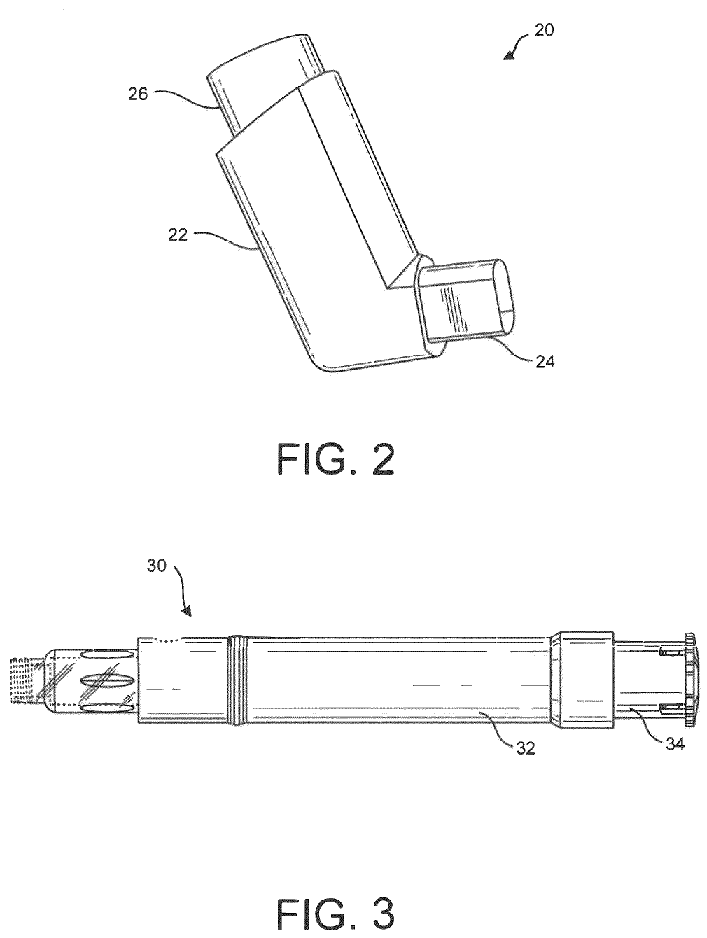

The compositions are also particularly well suited for use in producing medical products. For instance, referring to FIG. 2, an inhaler 20 is shown. The inhaler 20 includes a housing 22 attached to a mouthpiece 24. In operative association with the housing 22 is a plunger 26 for receiving a canister containing a composition to be inhaled. The composition may comprise a spray or a powder.

During use, the inhaler 20 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 22, the mouthpiece 24 and the plunger 26 can all be made from a polymer composition as described above.

Referring to FIG. 3, another medical product that may be made in accordance with the present disclosure is shown. In FIG. 3, a medical injector 30 is illustrated. The medical injector 30 includes a housing 32 in operative association with a plunger 34. The housing 32 may slide relative to the plunger 34. The medical injector 30 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 32 and/or the plunger 34 can be made from a polymer composition as described above.

While the polyoxymethylene polymer composition and polymer articles produced therefrom of the present disclosure provide improved emission properties, the compositions and articles may also exhibit excellent mechanical properties (ISO Test 527). For example, when tested according to ISO Test No. 527, the polymer composition may have a tensile modulus of greater than about 1,200 MPa, such as greater than about 2,000 MPa. The tensile modulus is generally less than about 10,000 MPa.

The polymer composition can exhibit a notched Charpy impact strength at 23° C. (ISO Test 179-1) of greater than about 3 kJ/m², such as greater than about 6 kJ/m². The notched Charpy impact strength is generally less than about 20 kJ/m².

The present disclosure may be better understood with reference to the following example.

### EXAMPLES

The following examples were conducted in order to demonstrate some of the advantages and benefits of polymer compositions made according to the present disclosure.

### Example 1

Various polymer compositions were formulated, molded into test specimens, and tested for formaldehyde emission. The polymer compositions contained an oxymethylene copolymer. The polyoxymethylene polymer had a melt volume rate of about 9 cm³/10 min according to ISO Test 1133. In addition to the polyoxymethylene polymer, the polymer composition contained 0.25% by weight of a nucleant (polyoxymethylene terpolymer), 0.2% by weight of an antioxidant (unless otherwise noted, triethylene glycol bis(3-tert-butyl-4-hydroxy-5-methylphenyl)propionate, 0.2% by weight of ethylene bis(stearamide).

Various different additives were then combined with the above polymer composition and tested for formaldehyde emission. Each formulation was compounded on a 32 mm co-rotating twin-screw extruder (ZSK 32, Coperion, Germany). The test plaques were injection molded. The test plaques were molded at a temperature of 205° C. and were dried for two hours at 140° C. The test plaques had a thickness of 1 mm.

The samples were also tested according to the Ford 10-Liter Bag Method (hereinafter “10-Liter Bag Method”), which is Test Reference No. BZ108-01 (Jul. 2, 2018).

In addition to the ingredients described above, the polymer compositions tested also contained a formaldehyde stabilizer package. The formaldehyde stabilizer package contained tricalcium citrate in an amount of 0.05% by weight in combination with one or more emission control agents. The formulations were tested for formaldehyde emission according to the VDA 275 Test. The following table lists the emission control agents present in the formulations and the formaldehyde emission result.

| | | Formaldehyde |
|---|---|---|
| Sample | | Emission |
| No. | Emission Control Agent | (μg/g) |
| 1 | 0.05% melamine | 27.66 |
| 2 | 0.05% melamine and 0.05% copolyamide | 26.07 |
| 3 | 0.45% benzoguanamine and 0.05% copolyamide | 9.94 |
| 4 | 0.07% sebacic acid dihydrazide and 0.5% MDI | 24.89 |
| 5 | 0.07% sebacic acid dihydrazide and 0.25% | 0.43 |
| | substituted hydantoin | |
| 6 | 0.07% sebacic acid dihydrazide and 0.5% MDI | 31.34 |
| 7 | 0.07% dodecanedioic acid dihydrazide | 35.91 |
| | and 0.5% MDI | |
| 8 | 0.07% dodecanedioic acid dihydrazide and 0.25% | 0.39 |
| | substituted hydantoin | |
| 9 | 0.07% sebacic acid dihydrazide and 0.25% | 0.39 |
| | substituted hydantoin | |
| 10 | 0.07% dodecanedioic acid dihydrazide and 0.25% | 0.39 |
| | substituted hydantoin | |
| 11 | 0.07% dodecanedioic acid dihydrazide | 21.06 |
| | and 0.5% MDI | |

The substituted hydantoin above is 4-isopropyl-2,5-dioxoimidazolidine-1,3-di(propionohydrazide) which also is believed to have coupling agent properties. MDI in the table above is methylene diphenyl diisocyanate which is known as a coupling agent. In Sample Nos. 4, 5, 10 and 11 above, the formulation contained two phenolic antioxidants. The first phenolic antioxidant was present in an amount of 0.15% by weight and comprised triethylene glycol bis(3-tert-butyl-4-hydroxy-5-methylphenyl)propionate. The second phenolic antioxidant contained in the formulation was present in an amount of 0.05% by weight and comprised N,N′-(hexane-1,6-diyl)bis[3-(3,5-di-tert-butyl-4-hydroxyphenyl)propanamide]. As shown above, formulations containing the substituted hydantoin dramatically decreased formaldehyde emissions.

The formulations were also tested for formaldehyde emission using the 10-Liter Bag Method as described above. The following results were obtained:

| Sample | Formaldehyde Emission |
|---|---|
| No. | (μg/m³) |
| 1 | 2974 |
| 2 | 4520 |
| 3 | 1279 |
| 4 | 59 |
| 5 | 51 |
| 6 | 506 |
| 7 | 6485 |
| 8 | 32 |
| 9 | 40 |
| 10 | 49 |
| 11 | 8910 |

A formulation was also tested that contained 0.05% copolyamide in addition to the other components contained in the other formulations. The formaldehyde emission result was 5517 μg/m³.

The formulations were also tested for color stability. Again, the samples molded at a temperature of 205° C. were tested. The following results were obtained:

| | Yellowness | | | |
|---|---|---|---|---|
| Sample | tested according | | | |
| No. | to DIN 6167 | L* | a* | b* |
| Control | −6.69 | 78.51 | −0.69 | −2.60 |
| 1 | −6.96 | 78.89 | −0.65 | −2.74 |
| 2 | −6.78 | 79.75 | −0.63 | −2.70 |
| 3 | −6.69 | 79.05 | −0.68 | −2.62 |
| 4 | 3.89 | 87.58 | −0.11 | 1.94 |
| 5 | 1.97 | 87.94 | −0.12 | 1.01 |
| 6 | −4.17 | 73.96 | −0.23 | −1.63 |
| 7 | −3.92 | 74.20 | −0.26 | −1.52 |
| 8 | −3.68 | 73.87 | −0.08 | −1.47 |
| 9 | −3.65 | 74.50 | −0.08 | −1.48 |
| 10 | −3.80 | 74.54 | −0.11 | −1.53 |
| 11 | −3.23 | 74.79 | −0.27 | −1.27 |

The compositions were also tested for melt flow rate at 190° C. and at a load of 2.16 kg. The following results were obtained:

| Sample No. | Melt Flow Rate (cm³/10 min) |
|---|---|
| 1 | 7.04 |
| 2 | 7.56 |
| 3 | 7.73 |
| 4 | 6.86 |
| 5 | 7.64 |
| 6 | 6.48 |
| 7 | 6.45 |
| 8 | 7.67 |
| 9 | 7.50 |
| 10 | 7.46 |
| 11 | 6.68 |

### Example No. 2

Example No. 1 was repeated using the same process and components. The formulations were tested for formaldehyde emission under the VDA 75 Test and for melt flow rate. The following results were obtained:

| Sample | Emission Control | Formaldehyde | MFR (cm³/10 min) |
|---|---|---|---|
| No. | Agent | Emission (mg/kg) | (ISO Test 1133) |
| 12 | None | 65.90 | 8.48 |
| 13 | 0.05% melamine | 25.20 | 8.64 |
| 14 | 0.05% substituted | 28.30 | 8.39 |
| | hydantoin | | |
| 15 | 0.05% melamine, | 23.10 | 8.51 |
| | 0.05% substituted | | |
| | hydantoin | | |
| 16 | 0.05% melamine, | 13.80 | 8.49 |
| | 0.1% substituted | | |
| | hydantoin | | |
| 17 | 0.05% melamine, | 14.50 | 8.47 |
| | 0.2% substituted | | |
| | hydantoin | | |
| 18 | 0.05% sebacic acid | 27.30 | 8.27 |
| | dihydrazide | | |
| 19 | 0.05% sebacic acid | 5.70 | 8.20 |
| | dihydrazide, 0.05% | | |
| | substituted | | |
| | hydantoin | | |
| 20 | 0.05% sebacic acid | 0.50 | 8.34 |
| | dihydrazide, 0.1% | | |
| | substituted | | |
| | hydantoin | | |
| 21 | 0.05% sebacic acid | 0.80 | 8.37 |
| | dihydrazide, 0.2% | | |
| | substituted | | |
| | hydantoin | | |
| 22 | 0.1% substituted | 9.2 | 8.16 |
| | hydantoin | | |
| 23 | 0.2% substituted | 1.4 | 8.46 |
| | hydantoin | | |

The above formulations were also tested for color stability. The following results were obtained:

| | Yellowness | | | |
|---|---|---|---|---|
| Sample | tested according | | | |
| No. | to DIN 6167 | L* | a* | b* |
| 12 | −2.64 | 73.82 | −0.46 | −0.91 |
| 13 | −3.87 | 74.15 | −0.07 | −1.57 |
| 14 | −4.03 | 74.01 | −0.1 | −1.62 |
| 15 | −4.50 | 73.50 | −0.12 | −1.79 |
| 16 | −4.40 | 74.12 | −0.14 | −1.76 |
| 17 | −3.93 | 74.37 | −0.12 | −1.58 |
| 18 | −3.76 | 74.16 | −0.08 | −1.53 |
| 19 | −3.74 | 73.95 | −0.08 | −1.51 |
| 20 | −4.34 | 73.95 | −0.17 | −1.72 |
| 21 | −4.15 | 73.90 | −0.18 | −1.64 |
| 22 | −4.11 | 74.22 | −0.11 | −1.65 |
| 23 | −3.93 | 73.97 | −0.12 | −1.57 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a polyoxymethylene polymer; and
a formaldehyde stabilizer package for reducing formaldehyde emissions, the formaldehyde stabilizer package comprising at least one emission control agent, the emission control agent comprising a substituted hydantoin alone or a combination of an aliphatic carboxylic hydrazide and a substituted hydantoin in which the aliphatic carboxylic hydrazide is present in relation to the substituted hydantoin at a weight ratio of from about 1:1.1 to about 1:8.5.

2. A polymer composition as defined in claim 1, wherein the aliphatic carboxylic hydrazide is present in relation to the substituted hydantoin at a weight ratio of from about 1:1.5 to about 1:7.5.

3. A polymer composition as defined in claim 1, wherein the substituted hydantoin contains two hydrazino carbonyl alkyl groups.

4. A polymer composition as defined in claim 1, wherein the substituted hydantoin comprises 4-isopropyl-2,5-dioxoimidazolidine-1,3-di(propionohydrazide).

5. A polymer composition as defined in claim 1, wherein the aliphatic carboxylic hydrazide comprises sebacic acid dihydrazide, dodecanedioic acid dihydrazide or mixtures thereof.

6. A polymer composition as defined in claim 1, wherein the aliphatic carboxylic hydrazide is present in the polymer composition in an amount less than about 0.15% by weight.

7. A polymer composition as defined in claim 1, wherein the polymer composition displays a yellowness index when tested according to DIN 6167 at a molding temperature of 205° C. of less than 0 and greater than about −10.

8. A polymer composition as defined in claim 1, wherein the polymer composition displays an L* value at a molding temperature of 205° C. of less than about 80 and greater than about 60.

9. A polymer composition as defined in claim 1, wherein the polymer composition displays a formaldehyde emission when tested according to Test VDA-275 at a thickness of 1 mm, at a molding temperature of 205° C., and after drying for 2 hr. at 140° C. of less than about 1 ppm.

10. A polymer composition as defined in claim 1, wherein the polymer composition further comprises an acid scavenger, the acid scavenger comprising a metal salt of an organic acid.

11. A polymer composition as defined in claim 10, wherein the organic acid has a carbon chain length of 8 carbon atoms or less.

12. A polymer composition as defined in claim 10, wherein the acid scavenger comprises tricalcium citrate.

13. A polymer composition as defined in claim 10, wherein the acid scavenger is present in the polymer composition in an amount less than about 0.5% by weight and in an amount greater than about 0.001% by weight.

14. A polymer composition as defined in claim 1, wherein the polymer composition displays a formaldehyde emission when tested according to a 10-Liter Bag Test of less than about 100 μg/m³.

15. A polymer composition as defined in claim 1, wherein the substituted hydantoin is present in the polymer composition in an amount greater than about 0.05% by weight and in an amount less than about 0.5% by weight.

16. A polymer composition as defined in claim 1, wherein the polyoxymethylene polymer has a melt flow rate of from about 5 cm³ per 10 min to about 15 cm³ per 10 min when tested at 190° C. and at a load of 2.16 kg.

17. A polymer composition as defined in claim 1, wherein the polymer composition further contains a nucleant in an amount from about 0.05% by weight to about 1% by weight, a phenolic antioxidant in an amount from about 0.05% to about 2% by weight, and a lubricant in an amount from about 0.05% to about 1.5% by weight.

18. A polymer composition as defined in claim 1, wherein the polymer composition further contains a thermoplastic elastomer in an amount from about 5% to about 30% by weight.

19. A polymer composition as defined in claim 1, wherein the polymer composition further contains reinforcing fibers in an amount from about 3% by weight to about 40% by weight.

20. A polymer composition as defined in claim 1, wherein the polymer composition further contains a UV stabilizer.

21. A polymer composition comprising:
a polyoxymethylene polymer;
a formaldehyde stabilizer package for reducing formaldehyde emissions, the formaldehyde stabilizer package comprising at least one emission control agent, the emission control agent comprising a substituted hydantoin alone or a combination of an aliphatic carboxylic hydrazide and a substituted hydantoin, the substituted hydantoin containing two hydrazino carbonyl alkyl groups; and
an acid scavenger comprising a metal salt of an organic acid, the organic acid having a carbon chain length of 8 carbon atoms or less.

22. A polymer composition comprising:
a polyoxymethylene polymer;
a formaldehyde stabilizer package for reducing formaldehyde emissions, the formaldehyde stabilizer package comprising at least one emission control agent, the emission control agent comprising a substituted hydantoin alone or a combination of an aliphatic carboxylic hydrazide and a substituted hydantoin, the substituted hydantoin containing two hydrazino carbonyl alkyl groups; and
wherein the polymer composition displays a yellowness index when tested according to DIN 6167 at a molding temperature of 205° C. of less than −1 and greater than about −10, an L* value at a molding temperature of 205° C. of less than about 80 and greater than about 60, a formaldehyde emission when tested according to Test VDA-275 at a thickness of 1 mm, at a molding temperature of 205° C., and after drying for 2 hr. at 140° C. of less than about 1 ppm, and a formaldehyde emission when tested according to a 10-Liter Bag Test of less than about 80 μg/m³.
